(19) United States
(12) Patent Application Publication
(10) Pub. No.: US 2009/0141066 A1
(43) Pub. Date: Jun. 4, 2009

(54) Recording Device

(75) Inventor: Goro Okada, Aichi-ken (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Aichi-ken (JP)

(21) Appl. No.: 12/324,175

(22) Filed: Nov. 26, 2008

(30) Foreign Application Priority Data
Nov. 30, 2007 (JP) 2007-310363

(51) Int. Cl. B41J 29/393

(52) U.S. Cl. 347/19

(57) ABSTRACT

A recording device may include a conveying mechanism including a peripheral surface that has an endless loop shape and includes a transmissive region. The conveying mechanism may convey a recording medium placed on the peripheral surface by rotation of the peripheral surface. A recording head may include a plurality of nozzles ejecting liquid drops and opposing the peripheral surface. The recording head may record an image on the recording medium conveyed by the conveying mechanism, by ejecting liquid drops from the nozzles. A transmissive state detection sensor may detect liquid drops ejected from the nozzles onto the transmissive region. The transmissive state detection sensor may be positioned in an inside space of the peripheral surface.

### CROSS REFERENCE TO RELATED APPLICATION

This application claims priority to Japanese Patent Application No. 2007-310363, filed Nov. 30, 2007, the entire subject matter and disclosure of which is incorporated herein by reference.

### BACKGROUND OF THE DISCLOSURE

1. Field of the Disclosure

The features herein relate to a recording device that records an image on a recording medium by ejecting liquid drops onto the conveyed recording medium (e.g., an ink jet printer).

2. Description of the Related Art

A known ink jet printer includes a conveying mechanism conveying the recording medium (e.g., paper) placed on an outer surface of an endless conveying belt, and a recording head having a plurality of nozzles that eject ink drops onto the recording medium conveyed by the conveying mechanism. In such an ink jet printer, nozzles may fail to eject ink properly if paper powder enters the nozzles, or with thickening of ink in the nozzles. This results in reduction in quality of printed image. Wherein, a known ink jet printer, in order to detect an ejection failure of nozzles, prints a test pattern on a recording medium by a recording head, and reads the test pattern by a reading unit positioned in an upper part of a conveying mechanism.

However, according to the above-described ink jet printer, the reading portion is positioned in an upper part of the conveying mechanism, increasing the size of the ink jet printer.

### SUMMARY OF THE INVENTION

A need has arisen for a recording device allowing space saving while detecting ejection failures of nozzles.

According to one embodiment herein, a recording device may include a conveying mechanism including a peripheral surface that has an endless loop shape and includes a transmissive region, the conveying mechanism conveying a recording medium placed on the peripheral surface by rotation of the peripheral surface; a recording head including a plurality of nozzles ejecting liquid drops and opposing the peripheral surface, the recording head recording an image on the recording medium conveyed by the conveying mechanism, by ejecting liquid drops from the nozzles; and a transmissive state detection sensor detecting liquid drops ejected from the nozzles onto the transmissive region, the transmissive state detection sensor being positioned in an inside space of the peripheral surface.

Other objects, features and advantages will be apparent to those skilled in the art from the following detailed description and accompanying drawings.

### BRIEF DESCRIPTION OF THE DRAWINGS

Embodiments of a recording device are described with reference to the accompanying drawings, which are given by way of example only, and are not intended to limit the present patent.

FIG. 1 is a side view of an ink jet printer according to an embodiment.

FIG. 2 is a plan view of a conveying belt.

FIG. 3 is a plan view of the conveying belt which is traveling.

FIG. 4 is a plan view of a head body.

FIG. 5 is an enlarged diagram of a head region enclosed by a chain line in FIG. 4. Pressure chambers 110, apertures 112, and nozzles 108, for convenience of explanation, are depicted with solid lines, although in practice some of the features (e.g., the chambers 110) may lie underneath other illustrated features.

FIG. 6 is a sectional view taken away along a line VI-VI in FIG. 5.

FIG. 7 is a functional block diagram of a control unit.

FIGS. 8A and 8B are diagrams showing operations of a cleaning mechanism.

FIG. 9 is a flowchart showing operations in an ejection examination of an ink jet head.

FIG. 10 is a sectional side view of a conveying mechanism according to another embodiment.

FIG. 11 is a sectional view taken away along a line XI-XI in FIG. 10.

### DETAILED DESCRIPTION OF EMBODIMENTS

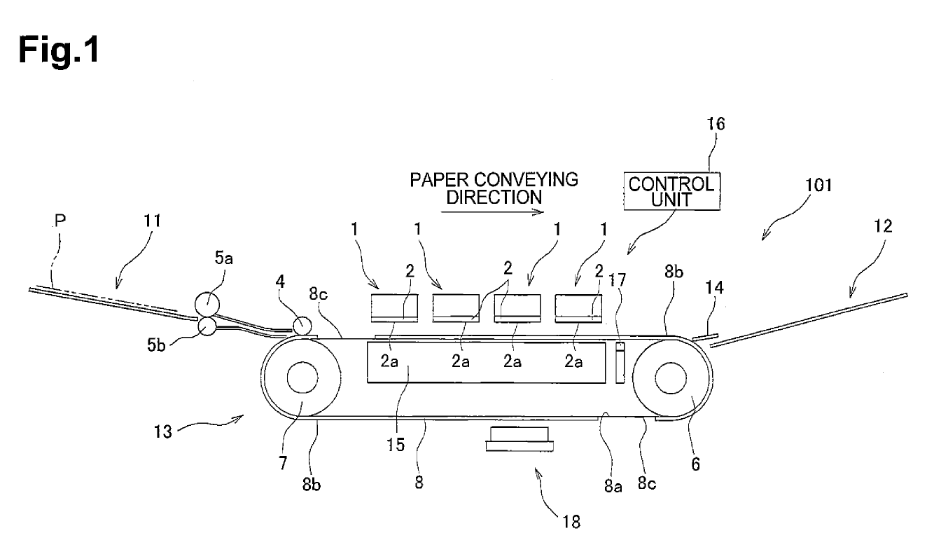

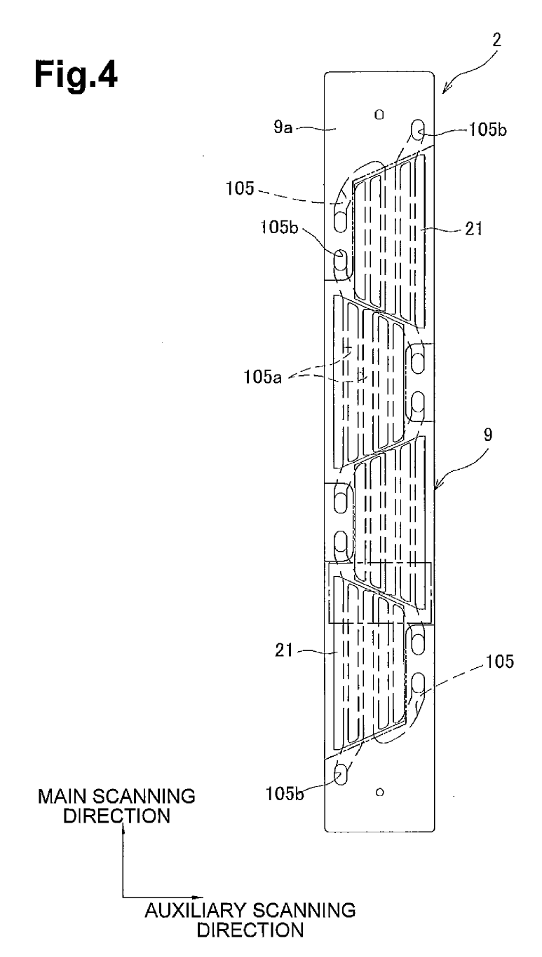

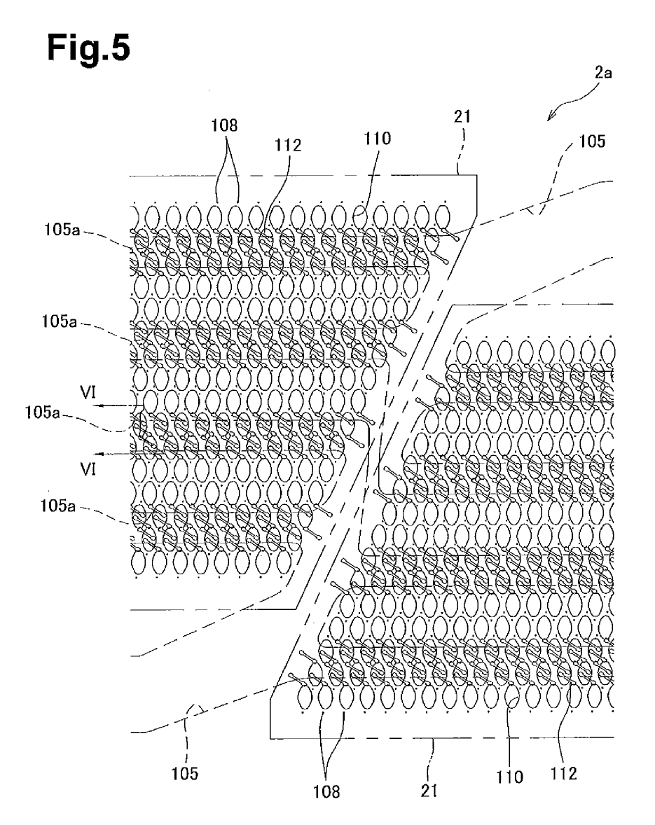

Various embodiments, and their features and advantages, may be understood by referring to FIGS. 1-11, like numerals being used for corresponding parts in the various drawings.

Referring to FIG. 1, the ink jet printer 101 may be a color ink jet printer including a plurality of, e.g., four, ink jet heads 1. In this ink jet printer 101, a paper feed unit 11 may be positioned on the left side of the figure, and a paper discharge unit 12 may be positioned on the right side thereof.

A paper conveying path on which paper P is conveyed from the paper feed unit 11 toward the paper discharge unit 12 may be positioned inside the ink jet printer 101. A plurality of, e.g., two, feed rollers 5a and 5b that pinch and convey the paper P may be positioned downstream of the paper feed unit 11. The plurality of feed rollers 5a and 5b may be used for feeding the paper P from the paper feed unit 11 toward the right side of the figure. The plurality of feed rollers 5a and 5b may send forth the paper P at timing when the paper P is placed on an adhesive belt 8b of a conveying belt 8. A conveying mechanism 13 may be positioned in an intermediate portion of the paper conveying path. The conveying mechanism 13 may include a plurality of, e.g., two, belt rollers 6 and 7, an endless conveying belt 8 looped over the plurality of rollers 6 and 7, and a platen 15 positioned in a region enclosed by the conveying belt 8.

The platen 15 may be used for supporting the conveying belt 8 to prevent the conveying belt 8 from warping downward at a position opposite the ink jet heads 1. A nip roller 4 may oppose the belt roller 7. The nip roller 4 may be a roller for pressing down the paper P fed from the paper feed unit 11 by the feed rollers 5a and 5b and placing the paper P on the surface of the adhesive belt 8b.

The conveying belt 8 may travel by the conveying motor 19 rotating the belt roller 6. The conveying belt 8 may convey the paper P placed on the surface of the adhesive belts 8b toward the paper discharge unit 12 while adhesively holding the paper P.

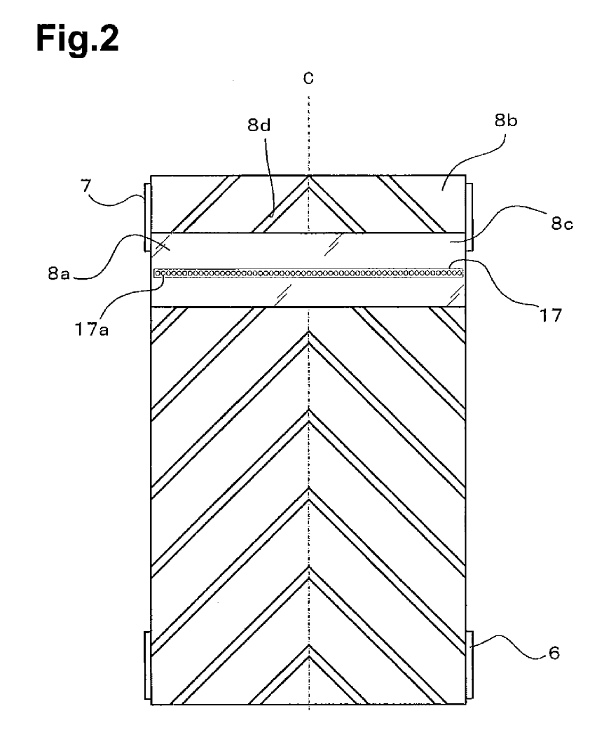

Referring to FIGS. 1 and 2, in the inside space of the conveying belt 8, an image sensor 17 may be positioned downstream of the platen 15 in the conveying direction. The image sensor 17 may be a line sensor, e.g., Contact Image Sensor, including a plurality of lenses 17a arranged in the width direction of the conveying belt 8 and an optical sensor device detecting light from each of the lenses 17a.

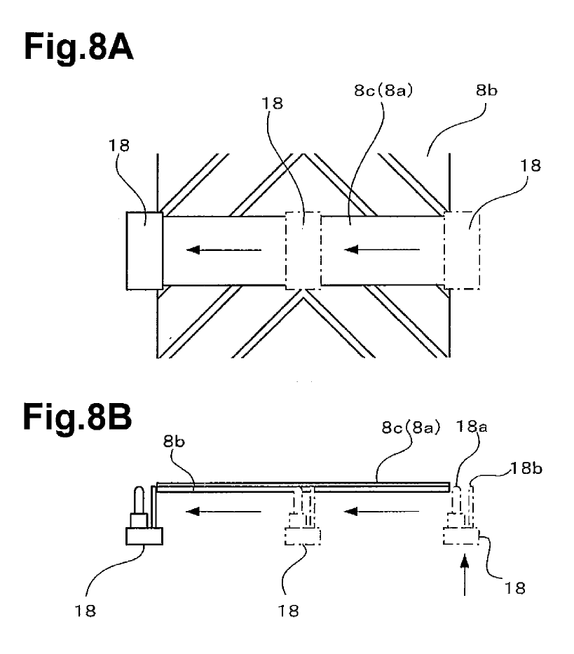

A cleaning mechanism 18 may be positioned under the conveying belt 8. The cleaning mechanism 18 may clean the surfaces of the transmissive regions 8c. The cleaning mechanism 18 (illustrated in greater detail in FIG. 8b) may include a sponge-shaped cleaning liquid application portion 18a that holds a cleaning liquid supplied from a cleaning liquid tank, and a blade 18b having a rectangular shape and made of an elastic material, e.g., rubber or a resin. The cleaning liquid application portion 18a and the blade 18b may be located adjacent to each other in the width direction of the conveying belt 8. The cleaning mechanism 18 may be configured to be movable vertically (e.g., away from the belt) or in the width direction of the conveying belt 8 by a movement mechanism.

A release mechanism 14 may be positioned just downstream of the conveying belt 8. The release mechanism 14 may be configured to release the paper P adhesively held on the surface of the adhesive belt 8b of the conveying belt 8 from the adhesive belt 8b, and guide the paper P toward the paper discharge unit 12 located on the right side in the FIG. 1.

The plurality of e.g., four, ink jet heads 1 may be positioned side by side along the conveying direction. The plurality of ink jet heads 1 may correspond to four color inks, e.g., magenta, yellow, cyan, and black. This ink jet printer 101 may be a line type printer. The plurality of ink jet heads 1 each may have a head body 2 on the bottom end thereof. The head body 2 may have a rectangular parallelepiped shape that is long and narrow in a direction perpendicular to the conveying direction. A bottom surface of the head body 2 may be configured to be an ink ejection surface 2a opposing the outer surface of the conveying belt 8. When the paper P conveyed by the conveying belt 8 passes immediately under the plurality of head bodies 2 one after another, inks of some colors may be ejected from the ink ejection surfaces 2a onto top surfaces of the paper P, whereby a desired color image may be formed on each of the top surfaces of the sheet of the paper P.

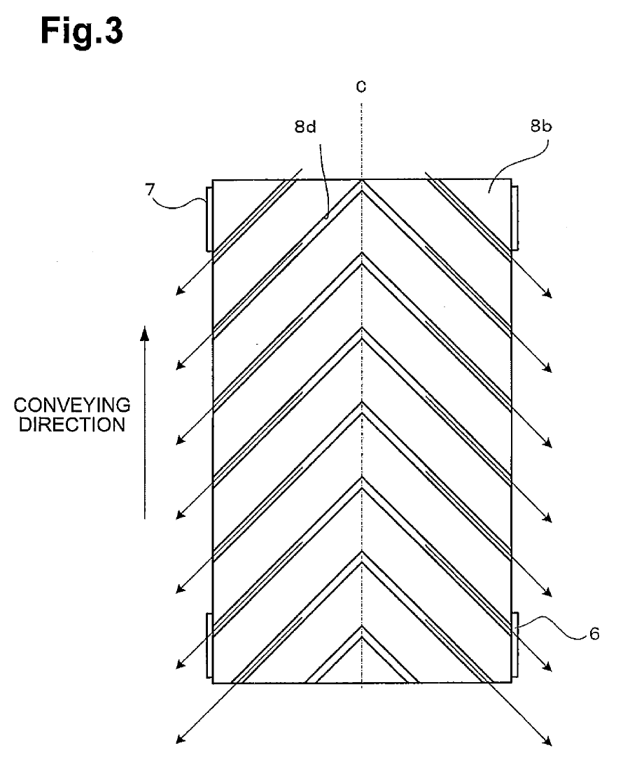

Referring to FIGS. 2 and 3, the conveying belt 8 may include a transmissive substrate 8a and a plurality of, e.g., two, adhesive belts 8b. The transmissive substrate 8a may have an endless loop configuration having a shape of an elongated circle in side view. The plurality of adhesive belts 8b may have a rectangular shape which have the same width as the width of the substrate 8a and extend in one direction in plan view. The plurality of adhesive belts 8b are stuck on an outer peripheral surface of the substrate 8a to be equidistantly spaced from each other in a peripheral direction. The extending direction of the adhesive belts 8b and the peripheral direction of the substrate 8a may coincide with each other. A plurality of regions exposed between the adhesive belts 8b on the outer peripheral surface of the substrate 8a may be configured to be a transmissive region 8c having optically transmissive property.

An adhesive layer for adhesively holding the paper P may be positioned on a surface of each of the adhesive belts 8b. The adhesive layer may include a silicon resin or the like. A plurality of grooves 8d may be formed on the surface of the adhesive belts 8b. The plurality of grooves 8d may extend toward the outside from a center C in the width direction of the adhesive belt 8b, as the conveying belt 8 travels toward the upstream side in the conveying direction of the paper P. Therefore, air flow heading for the outside from the center C may be formed by the conveying belt 8 traveling along the conveying direction. Paper powder or dust may be pushed outside the conveying belt 8 by the air flow, alleviating the risk of clogging the ink jet heads 1. Here, the grooves 8d are not necessarily required to be provided.

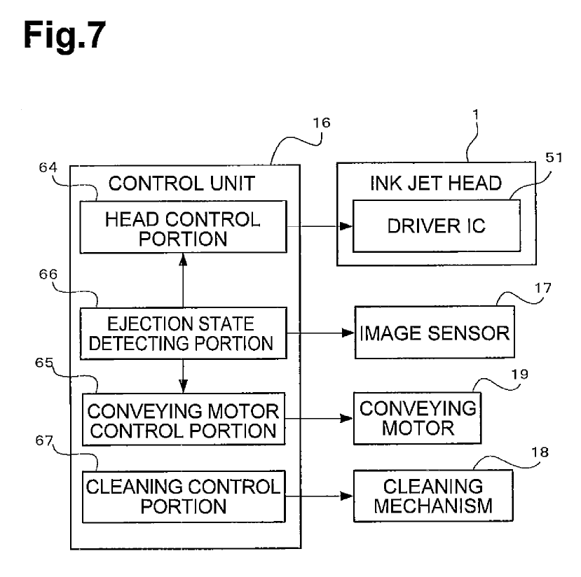

A reservoir unit that supplies ink, and a driver IC 51 (FIG. 7) that generates a drive signal for driving actuator unit 21 may be installed to the head body 2, which may be part of the ink jet head 1.

A plurality of e.g., four, actuator units 21 may be positioned on a top surface 9a of a flow path unit 9 in the head body 2. Ink flow paths containing pressure chambers 110 and the like may be formed in the flow path unit 9. The actuator unit 21 may include a plurality of actuators corresponding to respective pressure chambers 110. The actuator unit 21 may perform a function of selectively giving ejection energy to ink within pressure chambers 110, upon being driven by the driver IC 51.

The flow path unit 9 may have a rectangular parallelepiped shape. Ten ink supply ports 105b may be opened, corresponding to ink outflow path of the reservoir unit, on the top surface 9a of the flow path unit 9. Manifold flow paths 105 and auxiliary manifold flow paths 105a branched from each of the manifold flow paths 105 may be formed inside of the flow path unit 9. The ink ejection surface 2a may have a large number of nozzles 108 arranged in a matrix configuration on the bottom surface of the flow path unit 9. The pressure chambers 110 may also be arranged in a matrix configuration on a fixed surface of the actuator unit 21 in the flow path unit 9.

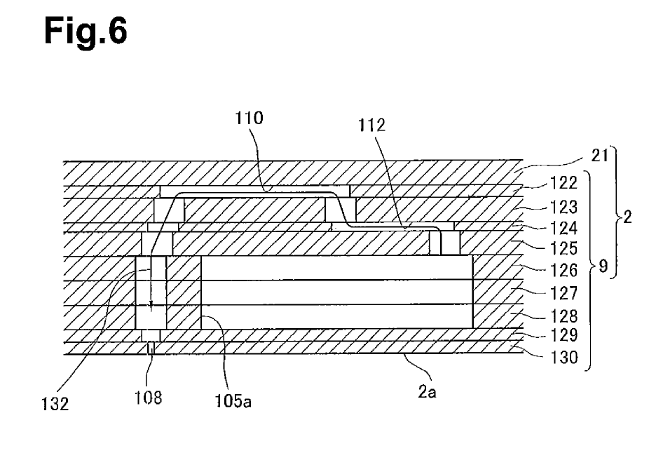

Referring to FIG. 6, the flow path unit 9 may comprise plates 122 to 130 made of a metal such as stainless steel. The plates 122 to 130 each may have a rectangular plane that is long in a main scanning direction. Through-holes formed in the plates 122 to 130 may be connected by stacking the plates 122 to 130 while aligning them with one another. A plurality of individual ink flow paths 132 from the manifold flow paths 105 up to the auxiliary manifold flow paths 105a, and those from exits of auxiliary manifold flow paths 105a through the pressure chambers 110 up to the nozzles 108 may be formed within the flow path unit 9.

Ink supplied from the reservoir unit into the flow path unit 9 via the ink supply ports 105b may be branched from each of the manifold flow paths 105 into the auxiliary manifold flow paths 105a. Ink within the auxiliary manifold flow paths 105a may flow into the individual ink flow paths 132 and may arrive at the nozzles 108 via the apertures 112 functioning as throttling members and at the pressure chambers 110.

Referring to FIG. 7, only one of the plurality of ink jet heads 1 is schematically illustrated. The control unit 16 may include a head control portion 64, a conveying motor control portion 65, an ejection state detecting portion 66, and a cleaning control portion 67. The functional diagram in FIG. 7 is, as its name implies, functional in nature, and the specific implementation may be done using any desired combination of hardware and/or software. For example, the various portions described below may be implemented as computer-executable instructions stored on a computer-readable medium, a microprocessor, or in separate circuitry.

The head control portion 64 may be operative to detect ejection timing of ink drops from the nozzles 108 by outputting a control signal to the driver IC 51 to form an image on the paper P conveyed by the conveying mechanism 13. The conveying motor control portion 65 may be operative to control the drive speed of the conveying motor 19 such that the conveying belt 8 travels at a predetermined speed pattern.

The ejection state detecting portion 66 may be operative to detect ejection states of ink drops concerning all the nozzles 108, in an ejection examination of the ink jet head 1. Specifically, firstly, the ejection state detecting portion 66 may cause the conveying belt 8 to travel via the conveying motor control portion 65. When the transmissive region 8c of the conveying belt 8 becomes opposed the ink ejection surface 2a of the ink jet head 1 to be examined, the ejection state detecting portion 66 may cause, via the head control portion 64, the pertinent ink ejection surface 2a to eject ink drops from all the nozzles thereof at all once. As a consequence, the ejected ink may drop land onto the surface of the transmissive region 8c, thereby forming dots on the surface of the transmissive region 8c.

Thereafter, when the transmissive region 8c in the conveying belt 8 passes above the image sensor 17, the ejection state detecting portion 66 may read, by the image sensor 17, states, e.g., presence/absence and forming position, of each of the dots formed in the transmissive region 8c. Since the transmissive region 8c has optical transmissive property (e.g., is transparent), states of each of the dots formed in the transmissive region 8c may be able to read even from the image sensor 17 disposed in the inside space of the conveying belt 8. The ejection state detecting portion 66 may detect ejection states of ink drops concerning each of the nozzles 108 on the basis of reading results by the image sensor 17. That is, if a dot that should be formed is not formed in the transmissive region 8c, the ejection state detecting portion 66 may detect that a nozzle 108 corresponding to the pertinent dot is in an ejection incapable state. If a dot is formed at a position different from a position where the dot should be formed, the ejection state detecting portion 66 may detect that a nozzle 108 corresponding to the pertinent dot is in an ejection failure state. When such an ejection anomaly, e.g., ejection incapability or ejection failure, has been detected, the ejection state detecting portion 66 may notify a control panel, a higher level computer, or the like of content of the ejection anomaly. Thereafter, in order to clean the transmissive region 8c by the cleaning mechanism 18, the ejection state detecting portion 66 may stop the travel of the conveying belt 8 via the conveying motor control portion 65 when the transmissive region 8c has arrived at a cleaning position that is a position opposable to the cleaning mechanism 18. When ejection anomaly has been detected, purge processing for discharging a large amount of ink from the nozzles 108 may be performed based on an instruction from the user or by automatic processing, thereby allowing an achievement of recovery of the nozzle 108 from ejection failure.

Referring to FIG. 8, the cleaning control portion 67 may be operative to control operations of the cleaning mechanism 18. During a stand-by state, the cleaning liquid application portion 18a may be located nearer to the conveying belt 8 than the blade 18b in the cleaning mechanism 18. When the transmissive region 8c stops at a cleaning position and cleaning is to be performed, the cleaning control portion 67 may raise the cleaning mechanism 18 such that a front end of each of the cleaning liquid application portion 18a and the blade 18b become flush with the surface of the transmissive region 8c, or so that the front end of each of the cleaning liquid application portion 18a and the blade 18b become slightly higher than the surface of the transmissive region 8c. Then, the cleaning control portion 67 may move the cleaning mechanism 18 toward the left side (cleaning direction), across the transmissive region 8c in the width direction of the conveying belt 8. As the cleaning mechanism 18 moves, the cleaning liquid application portion 18a may apply a cleaning liquid onto the surface of the transmissive region 8c, and concurrently, the blade 18b may remove the cleaning liquid applied by the cleaning liquid application portion 18a. Thereby, the transmissive region 8c may be reliably cleaned. In the discussion above, the cleaning liquid application portion 18a and blade 18b are described as having a common height. This is not required, however, and in alternative embodiments, one may be higher than the other. For example, the application portion 18a may be shorter than the blade 18b, or they may be configured differently as desired.

Upon completion of cleaning of the transmissive region 8c, the cleaning control portion 67 may lower the cleaning mechanism 18, and then may move it to the right side in FIG. 8 to thereby return the cleaning mechanism 18 to the stand-by state. The conveying belt 8 may be restarted to travel by the ejection state detecting portion 66.

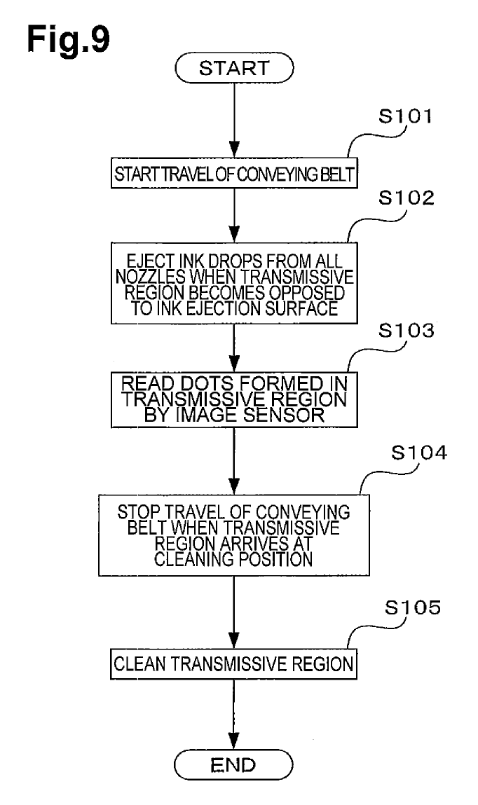

Referring to FIG. 9, upon receipt of an instruction from the user, the ejection examination of the ink jet head 1 may be performed immediately after power-on of the ink jet printer 101, or a predetermined time after the power-on, or before printing onto the paper P is started. Upon start of the ejection examination of the ink jet head 1, the process may advance to step S101 (hereinafter abbreviated as S101; the same applies to the other steps). In S101, the ejection state detecting portion 66 may cause the conveying belt 8 to travel, via the conveying motor control portion 65. The process may advance to S102 in which, when the transmissive region 8c of the conveying belt 8 opposes the ink ejection surface 2a of the ink jet head 1 to be examined, the ejection state detecting portion 66 may cause the pertinent ink ejection surface 2a to eject ink from all the nozzles thereof at all once via the head control portion 64. As a consequence, the ejected ink drops may land on the surface of the transmissive region 8c, thereby forming dots on the surface of the transmissive region 8c.

The process may advance to S103 in which, when the transmissive region 8c of the conveying belt 8 passes above the image sensor 17, the ejection state detecting portion 66 may read states of each of the dots formed in the transmissive region 8c by the image sensor 17, and the ejection state detecting portion 66 may detect ejection states of ink drops concerning each of the nozzles 108 on the basis of reading results by the image sensor 17. At this time, if an ejection anomaly is detected, the ejection state detecting portion 66 may notify the control panel, the higher level computer, or the like of content of the ejection anomaly. The process may advance to S104 in which, when the transmissive region 8c has arrived at the cleaning position, the ejection state detecting portion 66 may stop the travel of the conveying belt 8 via the conveying motor control portion 65.

Upon arrival of the transmissive region 8c at the cleaning position, the process may advance to S105. In S105, the cleaning control portion 67 may actuate the cleaning mechanism 18 to clean the transmissive region 8c. Upon completion of the cleaning of the transmissive region 8c, the cleaning control portion 67 may return the cleaning mechanism 18 to the stand-by state, thus ending the flowchart in FIG. 9. By performing the foregoing operations for each of the ink jet heads 1, ejection examinations of all of the ink jet heads 1 may be able to be carried out. Ejection examinations may be performed for each of the ink jet heads 1 sequentially, but it may be also be possible to simultaneously perform examinations with respect to a plurality of ink jet heads 1 by causing ink drops to be ejected from nozzles 108 concerning the plurality of ink jet heads 1 onto the transmissive region 8c. Ejection examination(s) may be performed with respect to only the specific nozzle(s) 108 by causing ink drops to be ejected from one or a plurality of specific nozzles 108.

According to the above-described embodiment, since the transmissive regions 8c with transmissive property are positioned on a portion of the conveying belt 8, and the image sensor 17 for detecting ejection states of the nozzles 108 through transmissive region 8c is positioned in the inside space of the conveying belt 8, it may be possible to achieve space saving of the ink jet printer 101. The image sensor 17 may be less prone to be contaminated because of its installation position below the conveying belt, or inside an area enclosed by the belt (e.g., the image sensor 17 faces one side of the conveying belt, while the paper and ink are on the opposite side of the conveying belt), helping to maintain its effectiveness.

Moreover, since the conveying belt 8 is an endless belt wound around the belt rollers 6 and 7, the shape of the conveying belt 8 may be able to be optionally selected to wind in whatever direction is desired by the placement of the rollers 6 and 7. This allows further space saving of the ink jet printer 101.

Furthermore, since the conveying belt 8 is constituted by sticking the plurality of, e.g., two, adhesive belts 8b onto the outer peripheral surface of the substrate 8a such that the transmissive region 8c is formed by a portion of the substrate 8a being exposed, the transmissive regions 8c may be able to be easily formed. In addition, since the adhesive layers are formed on the surfaces of the adhesive belts 8b, the paper P placed thereon may be able to be reliably held.

Furthermore, since the cleaning mechanism 18 has the cleaning liquid application portion 18a that applies a cleaning liquid onto the transmissive region 8c, and the blade 18b that removes the cleaning liquid applied onto the transmissive region 8c, it may be possible to reliably clean the transmissive region 8c. If no ejection anomaly is observed by the image sensor 17, the process may advance to image forming processing (e.g., proceeding to print a document) after the above-described cleaning processing has been completed on the basis of detection results. For example, rotation of the conveying belt 8 may be started. On the other hand, if an ejection anomaly is observed, rotation of the conveying belt 8 may be halted when the belt 8 is in the correct position for recovery processing, and recovery processing may be performed. For example, purge processing with respect to the ink jet head 1 may be performed.

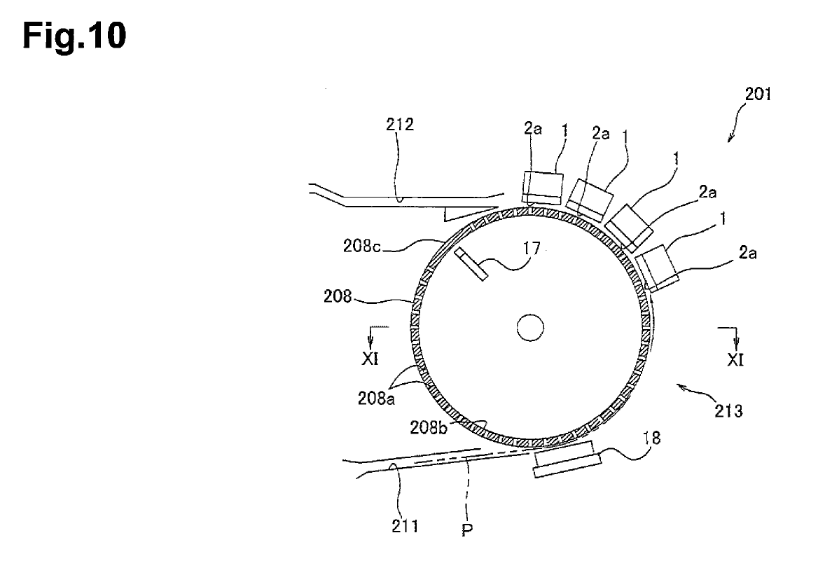

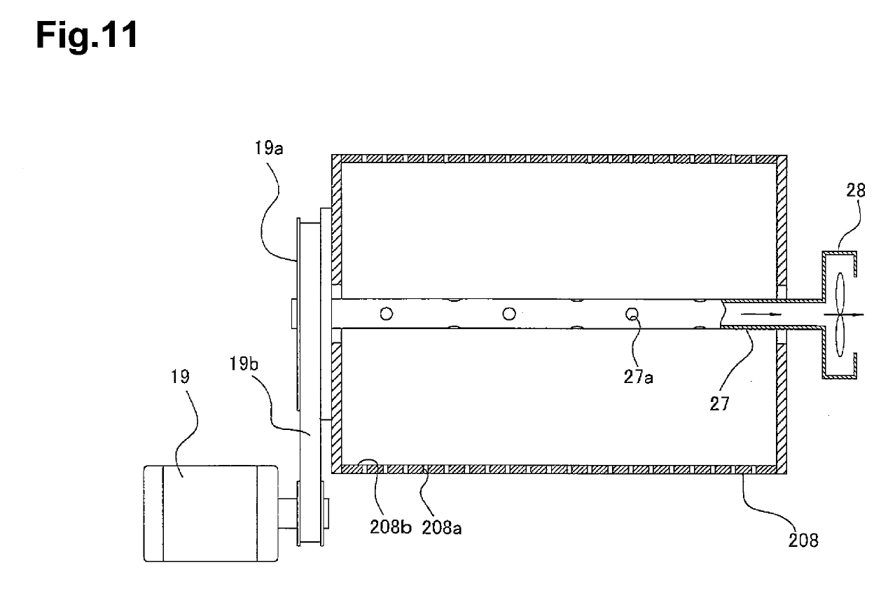

Referring to FIGS. 10 and 11, another embodiment is described below. Because mechanisms other than a conveying mechanism 213 may be substantially same as those in the above-described embodiment, these mechanisms are designated by the same symbols as those in the above-described embodiment, and description thereof is omitted. The ink jet printer 201 may include the conveying mechanism 213, a paper feed unit 211 positioned below the conveying mechanism 213, a paper discharge unit 212 positioned above the conveying mechanism 213, a plurality of, e.g., four, ink jet heads 1, an image sensor 17, and a cleaning mechanism 18.

The conveying mechanism 213 may be for conveying the paper P, and may include a drum 208 having a cylindrical shape with an axis extending perpendicular to the plane of FIG. 10. The drum 208 may be made of a transparent material such as a plastic, and may have a transmissive property (e.g., the shaded portions shown in FIG. 10 may be transparent). Both ends of the drum 208 in the extending direction may be closed, and the drum 208 may be supported by a hollow shaft 27 so as to be rotatable in its peripheral direction in the closed ends of drum 208.

A portion of region in the peripheral direction of the peripheral wall of the drum 208 may comprise a transmissive region 208c. A plurality of suction holes 208a that communicate an inside space 208b of the drum 208 with the outside may be formed in the region except the transmissive region 208c on the peripheral wall of the drum 208. A plurality of communication holes 27a that communicate the inside space 208b with the inside of the hollow shaft 27 may be formed in a peripheral wall of the hollow shaft 27 in the inside space 208b. The end of one side, i.e., the left side in FIG. 11, of the hollow shaft 27 may be sealed. The end of the other side of the hollow shaft may be connected with an air suction unit 28. Air within the inside space 208b may be sucked-in from the hollow shaft 27 via the communication holes 27a by driving the air suction unit 28. As a result, air flow heading for the inside space 208b through the suction holes 208a may be formed, thereby allowing the paper P to be attracted onto an outer peripheral surface of the drum 208.

A pulley 19a supported by the hollow shaft 27 so as to be rotatably in its peripheral direction, may be fixed to a surface on the left side in FIG. 11 of the drum 208. A belt 19b may be looped over the pulley 19a and a pulley mounted on a rotating shaft of a conveying motor 19. The paper P attractively held on the outer peripheral surface of the drum 208 may be conveyed by the conveying motor 19 rotating the drum 208 via the belt 19b and the pulley 19a in an arrow direction, i.e., counterclockwise direction in FIG. 10.

A plurality of e.g., four, ink jet heads 1 may be arranged along the conveying direction, just upstream of the paper discharge unit 212 in the conveying direction. Ink ejection surfaces 2a of the respective ink jet heads 1 may oppose the outer peripheral surface of the drum 208. When sheets of the paper P conveyed by the drum 208 pass immediately under the plurality of ink jet heads 1 one after another, inks of some colors may be ejected from the ink ejection surfaces 2a onto the top surfaces of the sheets of the paper P, i.e., printed surfaces, whereby a desired color image may be able to be formed on each of the printed surfaces of the sheets of the paper P.

An image sensor 17 may be positioned below the paper discharge unit 212 in the inside space 208b of the drum 208. The image sensor 17 may read states of dots formed within the transmissive region 208c of the drum 208, in an ejection examination of the ink jet head 1. The cleaning mechanism 18 that cleans the transmissive region 208c in the ejection examination of the ink jet head 1 may be positioned just downstream of the paper feed unit 211 in the conveying direction.

According to this alternative embodiment, since the image sensor 17 for ascertaining ejection states of the nozzles 108 is positioned in the inside space, space saving of the ink jet printer 201 may be able to be achieved.

Furthermore, since the conveying mechanism 213 has a drum 208, and the drum does not elastically deform by virtue of its rotation, durability of the conveying mechanism 213 may be enhanced.

Moreover, since, air flow heading for the inside space 208b from the outside through the suction holes 208a is formed by driving the air suction unit 28, and the paper P is attracted onto the outer peripheral surface of the drum 208, attraction force may be less prone to deteriorate, which allows the paper P to be stably held.

Although embodiments have been described in detail herein, the scope of this patent is not limited thereto. It will be appreciated by those of ordinary skill in the relevant art that various modifications may be made without departing from the scope of the invention. Accordingly, the embodiments disclosed herein are exemplary, and are not limiting. It is to be understood that the scope of the invention is to be determined by the claims which follow.

As an example modification, in the above-described embodiment, although the conveying belt 8 may have a configuration in which two adhesive belts are stuck on the outer peripheral surface of the substrate 8a so that the transmissive regions 8c are formed by a portion of the substrate 8a being exposed, the transmissive region may be otherwise constructed. For example, the transmissive regions may be formed by cutting away a portion of the endless loop-shaped conveying belt and providing a transmissive material to the cut-away regions.

In the above-described embodiment, although an adhesive layer may be positioned on the surface of each of the adhesive belts 8b, a charged belt with a charged layer formed on the surface thereof may be used instead of the adhesive belt 8b. In this case, the conveying mechanism may further include a charging mechanism that charges a belt to be charged and a mechanism that discharges the charged belt that has been charged. Of course, instead of the adhesive belt 8b, a construction having a plurality of communication holes and sucking-in air from inside region of the belt, may be used.

In addition, in the above-described embodiment, although the cleaning mechanism 18 may be configured to have the cleaning liquid application portion 18a that applies a cleaning liquid onto the transmissive region 8c, and the blade 18b that removes the cleaning liquid applied onto the transmissive region 8c, any other configurations may be employed as long as they clean the transmissive region 8c. For example, a configuration without the cleaning liquid application portion 18a, or alternatively, a configuration without the blade 18b may be used. Moreover, instead of the blade 18b, a configuration for shaking off the applied cleaning liquid using a porous ink absorbing member may also be utilized.

Furthermore, in the above-described embodiment, although states of dots formed in the transmissive region 8c may be read using the image sensor 17, the states of dots formed in the transmissive region 8c may be read using a charged coupled device (CCD) instead of the image sensor 17.

Moreover, in the above-described embodiment, although the conveying belt 8 may be configured by sticking the two adhesive belts 8b onto the outer peripheral surface of the substrate 8a, the conveying belt 8 may be configured by sticking a single adhesive belt having the same surface configuration as that of the two adhesive belts 8b onto the outer peripheral surface of the substrate 8a. Alternatively, a plurality of adhesive belts having the same surface configurations may be stuck onto the outer peripheral surface of the substrate 8a along the conveying direction so as to be adjacent to one another.

What is claimed is:

1. A recording device comprising:
a recording medium conveyor having a peripheral surface that includes a transmissive region;
a recording head comprising a plurality of liquid ejection nozzles configured to eject liquid drops onto the peripheral surface; and
a transmissive state detection sensor configured to detect drops ejected from the nozzles onto the transmissive region of the conveyor, the transmissive state detection sensor being positioned in an inside space of the peripheral surface.

2. The recording device according to claim 1, wherein the transmissive state detection sensor comprises an image sensor arranged in a width direction of the peripheral surface.

3. The recording device according to claim 2, wherein the image sensor is a contact image sensor.

4. The recording device according to claim 2, wherein the image sensor is a charge coupled device.

5. The recording device according to claim 1, further comprising an ejection state detector configured to detect an ejection state on the basis of detection results of the transmissive state detection sensor, after the liquid drops have been ejected from the nozzles onto the transmissive region.

6. The recording device according to claim 1, wherein the peripheral surface is an endless belt looped over a plurality of rollers.

7. The recording device according to claim 1, wherein the peripheral surface is a drum having a cylindrical shape.

8. The recording device according to claim 7,
wherein a plurality of suction holes communicating the inside space with the outside are formed in the peripheral surface, and,
the device further comprises a suction unit configured to draw air into the inside space from outside the drum through the suction holes.

9. The recording device according to claim 1, the peripheral surface further comprising:
a transmissive substrate having an endless loop shape; and
an adhesive layer placed on an outer peripheral surface of the substrate, wherein the transmissive region is formed by a portion of the substrate being exposed by the adhesive layer.

10. The recording device according to claim 1, the peripheral surface further comprising:
a transmissive substrate having an endless loop shape; and
a charged layer placed on an outer peripheral surface of the substrate, wherein the transmissive region is formed by a portion of the substrate being exposed by the charged layer.

11. The recording device according to claim 1, further comprising:
a cleaning controller configured to cause a cleaning mechanism to clean the transmissive region, after the ejection state detector has detected the ejection state.

12. The recording device according to claims 11, further comprising the cleaning mechanism, the cleaning mechanism further comprising:
an applying unit configured to apply cleaning liquid to the transmissive region; and
a removal unit configured to remove the cleaning liquid from the transmissive region.

13. A printer, comprising:
a print medium conveying surface having a transmissive region;
a print head positioned on a first side of the conveying surface; and
a sensor positioned on a second side of the conveying surface, opposite the first side, wherein the sensor is configured to detect drops printed on the first side of the conveying surface on the transmissive region by the print head.

14. The printer of claim 13, wherein the print medium conveying surface is a surface of a conveyor belt.

15. The printer of claim 14, wherein the belt includes a transmissive substrate and one or more adhesive layers.

16. The printer of claim 13, wherein the belt includes a charge layer.

17. The printer of claim 13, wherein the print medium conveying surface is a surface of a drum.

18. The printer of claim 17, wherein the drum is formed of a transmissive material.

19. The printer of claim 18, wherein the drum further comprises a plurality of suction holes on the conveying surface.

20. A print anomaly detection method, comprising:
optically detecting, from a position inside a print medium conveyor surface, ink droplets deposited on a transmissive region on an outside surface of the print medium conveyor surface; and
determining when a print anomaly has occurred based on positions of the detected ink droplets.
